(19) United States
(12) Patent Application Publication
(10) Pub. No.: US 2006/0060607 A1
(43) Pub. Date: Mar. 23, 2006

(54) Inner tank structure of drinking water dispenser

(76) Inventor: Kuei-Tang Chang, Banchiau City (TW)

Correspondence Address: Yi-Wen Tseng, 4331 Stevens Battle Lane, Fairfax, VA, 22033, US

(21) Appl. No.: 10/943,263

(22) Filed: Sep. 17, 2004

(51) Int. Cl. B67D 5/62

(52) U.S. Cl. 222/146.6

(57) ABSTRACT

An inner tank structure, having a plastic body in the form of a hollow barrel. The hollow barrel has an open top allowing water to supply therefrom. The inner tank is divided into an upper portion and a lower portion by a partitioning board laterally extending therein. The lower portion functions as a cold water tank. The cold water tank includes a cryogenic device substantially covering the whole exterior side surface of the cold water tank, and a metal member substantially covering the whole exterior side surface of the cryogenic device.

### BACKGROUND OF THE INVENTION

The present invention relates in general to an inner tank structure of a drinking water dispenser, and more particularly, to a plastic inner tank structure of a water dispenser that has improved cryogenic effect.

To obtain a sufficient cryogenic effect, the conventional water dispenser that provides both hot and cold drinking water typically uses metal for fabricating cold water tank.

As the metal water tank is more costly, some water dispenser also uses plastic material for fabricating the cold water tank. However, as the contact between the cryogenic device and the cold water tank is typically linear, the contact area is normal insufficient to provide proper thermal conduction. When the cold water tank is deformed during installation, the cooling effect of the water is further degraded, and the time for cooling water is consequently longer.

### BRIEF SUMMARY OF THE INVENTION

An inner tank structure of a water dispenser is provided. The inner tank is fabricated from relatively inexpensive material such as plastic. The structure of the inner tank provides a better contact to the cryogenic device, such that the cooling effect is improved.

As provided, the inner tank structure has a plastic body in the form of a hollow barrel. The hollow barrel has an open top allowing water to supply therefrom. The inner tank is divided into an upper portion and a lower portion by a partitioning board laterally extending therein. The lower portion functions as a cold water tank. The cold water tank includes a cryogenic device substantially covering the whole exterior side surface of the cold water tank, and a metal member substantially covering the whole exterior side surface of the cryogenic device.

### BRIEF DESCRIPTION OF THE DRAWINGS

The above objects and advantages of the present invention will be become more apparent by describing in detail exemplary embodiments thereof with reference to the attached drawings in which:

FIG. 1 is an exploded view of an inter tank used in a water dispenser;

FIG. 2 is a perspective view of the inner tank;

FIG. 3 shows a partial cross section of the inner tank; and

FIG. 4 shows the cross sectional view of the inner tank.

### DETAILED DESCRIPTION OF THE INVENTION

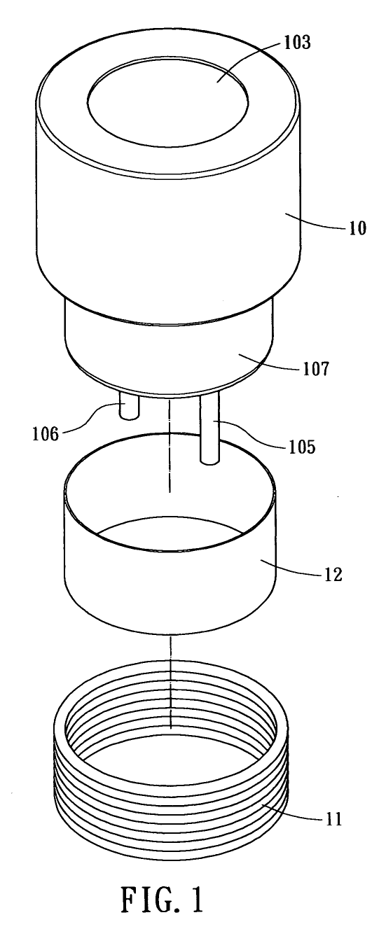

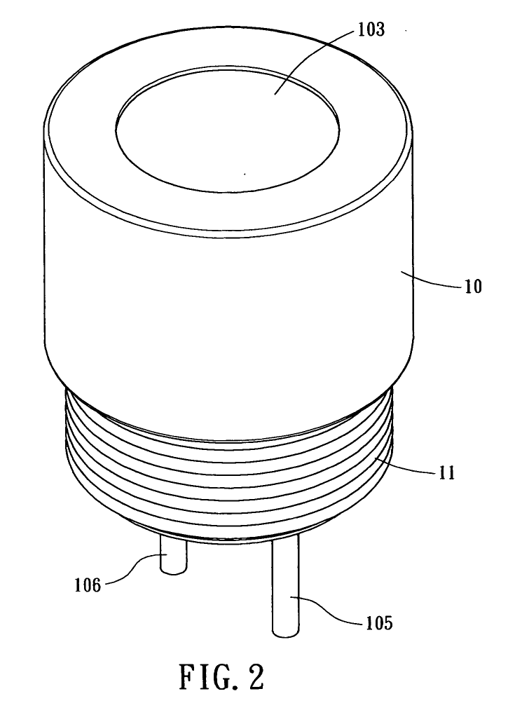

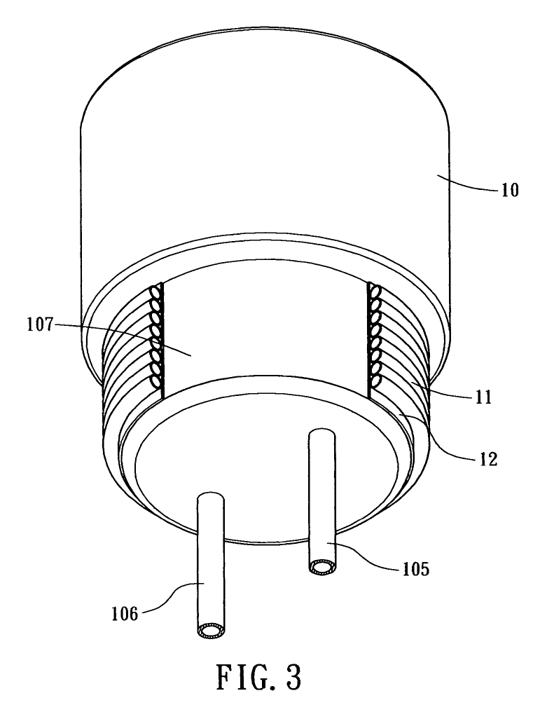

Referring to FIGS. 1-4, the inner tank used for a water dispenser includes a water tank 3 for containing the drinking water. In this embodiment, the water tank 3 is installed on the water dispenser for supplying drinking water to an inner tank 1 of the water dispenser. The inner tank 1 includes a plastic body 10, a cryogenic device 11 and a plurality of metal rings 12.

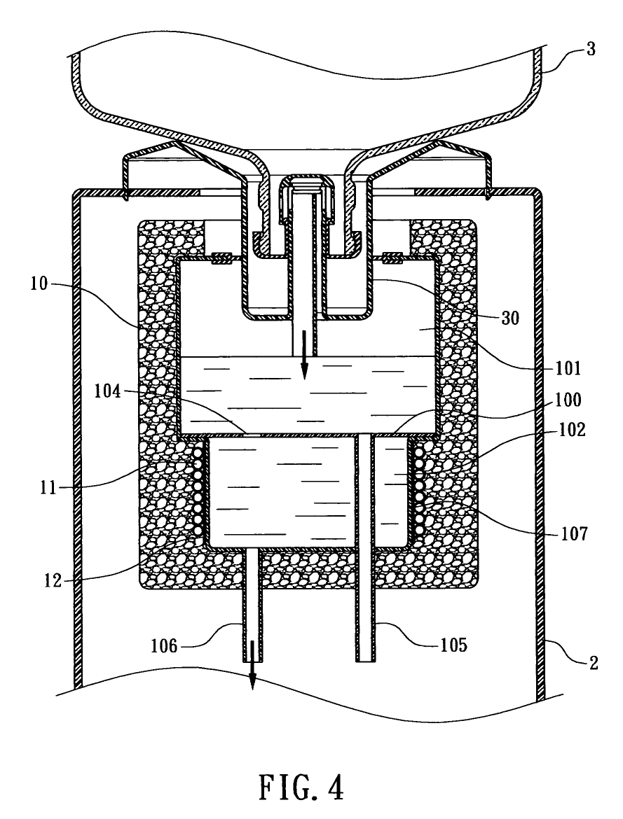

The plastic body 10 is preferably in a hollow barrel shape and includes a lateral partitioning board 100 (as shown in FIG. 4) to divide the plastic body 10 into an upper portion 101 and a lower portion 102. The top of the upper portion 101 has an opening 103 for receiving the drinking water supplied from the water tank 3, while the lower portion 102 is used as the cold water tank to produce and contain cold water. The partitioning board 100 is perforated with a through hole 104 allowing a part of the water contained in the upper portion 101 to flow in the lower portion 102. The inner tank 1 further comprises a conduit 105 extending through the lower portion 102 for conducting the drinking water from the upper portion 101 to a hot water tank (not shown).

As shown in FIGS. 1-3, the cryogenic device 11 is in the form of an annular shell attached to an exterior side surface 107 of the cold water tank 102 of the plastic body 10. Preferably but optionally, the whole exterior side surface 107 is completed covered by the cryogenic device 11, such that a large contact area is obtained between the cryogenic device 11 and the cold water tank 102, such that the cooling effect is greatly improved. The metal rings 12 are then closely attached to the cryogenic device 11 to provide sufficient dissipation for the heat of the cryogenic device 11.

As shown in FIG. 4, when the drinking water contained in the water tank 3 flows into the upper portion 101 of the inner tank 1, a portion of the water further flows into the cold water tank 102. The cryogenic device 12 enclosing the cold water tank 102 then effectively cool down the drinking water into cold water. As shown, a thermal insulating later is preferably mounted around the inner tank 1 to maintain the water temperature. The bottom of the cold water tank 102 includes a dispensing conduit 106 extending to a cold water valve (outlet), such that the user can dispense cold water from the cold water tank 102.

The cryogenic device 11 may be a vaporizer, and the metal ring 12 can be fabricated from copper or aluminum.

Thereby, the inner tank of the water dispenser can be fabricated from relatively inexpensive plastic material while the cooling effect is improved.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. An inner tank structure of a water dispenser, comprising:
a hollow plastic body for containing water, the plastic body having an exterior side surface;
a cryogenic device, attached to at least a portion of the exterior side surface of the hollow body; and
a metal member covering the cryogenic device.

2. The structure of claim 1, wherein the tank includes a plastic tank.

3. The structure of claim 1, wherein the tank has a top opening allowing water to flow therein.

4. The structure of claim 1, further comprising a partitioning board to partition the tank into an upper portion and a lower portion to serve as a cold water tank.

5. The structure of claim 4, wherein the partitioning board is perforated with a through hole allowing water to flow from the upper portion to the cold water tank.

6. The structure of claim 4, wherein tank further comprises conduit extending through the cold water tank to connect the upper portion to a hot water tank.

7. The structure of claim 4, wherein the tank further comprises a conduit connecting the cold water tank to a dispensing valve.

8. The structure of claim 4, wherein the cryogenic device covering the whole exterior side surface of the cold water tank.

9. The structure of claim 4, wherein the metal member covering the whole cryogenic device.

10. The structure of claim 1, wherein the cryogenic device includes a vaporizer.

11. The structure of claim 1, wherein the metal member includes bent copper.

12. The structure of claim 1, wherein metal member includes bent aluminum.

13. An inner tank of a water dispenser, comprising:
a plastic cold water tank, connected to a water supply and a cold water dispenser;
a cryogenic device encircling substantially the whole plastic cold water tank therein; and
a metal member encircling substantially the whole cryogenic device therein.

14. A water dispenser, comprising:
a water supply; and
an inner tank comprising:
an upper chamber in fluid communication with the water supply;
a cold water tank in fluid communication with the upper chamber;
a cryogenic device covering an exterior surface of the cold water tank; and
a metal member covering an exterior surface of the cryogenic device.

15. The water dispenser of claim 14, wherein the inner tank is fabricated from plastic material.

16. The water dispenser of claim 14, further comprising a thermal insulator to maintain water temperature of the cold water tank.
